(19) United States
(12) Patent Application Publication
(10) Pub. No.: US 2008/0200085 A1
(43) Pub. Date: Aug. 21, 2008

(54) Textile or Fabric

(75) Inventors: Michel P.B. Van Bruggen, Helmond (NL); Albert H.J. Immink, Eindhoven (NL); Martijn Krans, Den Bosch (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/915,441

(22) PCT Filed: May 30, 2006
(86) PCT No.: PCT/IB06/51718

§ 371 Date: Nov. 26, 2007

(30) Foreign Application Priority Data
May 31, 2005 (EP) 05104704.1

(51) Int. Cl. B32B 5/02; B32B 33/00; D03D 23/00

(52) U.S. Cl. 442/117; 428/221; 442/59; 28/140

(57) ABSTRACT

A textile or fabric (2) comprising a first light emitting component (4) and a second pressure sensitive component (6), wherein the first component comprises an output device adapted to emit an output signal that is dependent on a parameter of an applied pressure applied to the second component via the first component.

This invention relates to a textile or fabric, especially one that is suitable for incorporation into a touch sensitive light emitting textile device, and to a method of fabricating such a textile or fabric.

Known touch sensitive displays comprise a transparent or translucent touch sensitive film that is deposited over a display area. Such a film may consist of a transparent conductor with, for example, a capacitive sensor functionality.

In order to ensure that a reliable touch sensitive film is deposited over the display area, the substrate on which the display area is formed must be smooth and homogeneous.

A textile surface is, by definition, neither smooth nor homogeneous.

A woven textile is disclosed in International patent application No. WO 03/095729. The textile disclosed therein comprises a plurality of weave layers made up of a plurality of electrically insulating and/or electrically conductive yarn in the both the warp and the weft of the textile. An electrical function is provided by one or more circuit carriers disposed in cavities formed in the plural layers of the textile.

International patent application No. WO 2005/001678 discloses a device comprising an interface of textile construction having a touch sensitive switch. The switch is formed by inlaying one or more conductive fibres into a recess.

U.S. patent application No. U.S. 2004/0120684 describes a device in which a stress luminescent material is provided in part of each of a set of optical waveguides. The optical waveguides are disposed to intersect each other at an intersecting portion in which the stress luminescent material is present. Stress is applied to the stress luminescent material by depressing the intersecting portion between two optical waveguides with a finger. This causes the stress luminescent material to emit luminescence. The light emitted is guided in each of the waveguides that intersect.

It is an object of the present invention to provide a light emitting textile having a light output that is dependent upon at least one parameter of a pressure applied to the textile.

According to a first aspect of the present invention there is provided a textile or fabric comprising:
a first light emitting component,
a second, pressure sensitive component,
the first component comprising:
an output device adapted to emit an output signal that is dependent on a parameter of an applied pressure applied to the second component via the first component.

The term “textile” as used herein should be understood to include the term “fabric”, and vice versa.

Preferably, the first component comprises a fabric.

The textile according to the first aspect present invention is thus able to emit an output signal that is dependent upon a parameter of the applied pressure applied to the second component of the textile or fabric via the first component. An important feature of the first aspect of the present invention is that the second component is not directly contacted by a person or device applying the pressure. In other words, in use of the present invention, it is the first component with which a user interfaces, when using the textile.

A person using the textile will, for example, press a portion of the first component thus applying a pressure to the second component via the first component. The textile according to the first aspect of the present invention will emit an output signal that is dependent upon a parameter of the pressure applied to the second component.

Advantageously, the first component comprises a plurality of output devices.

Preferably, each of the output devices has an optical output signal. Advantageously, each of the output devices comprises a light emitting diode (LED).

Conveniently, the second component comprises a pressure sensitive material impregnated into the second component.

Alternatively, the second component comprises a plurality of pressure sensitive yarns each of which yarns comprises a pressure resistive or piezoresistive material.

Advantageously, the pressure sensitive component comprises a pressure resistive material. When pressure is applied to the second component through the first component, the pressure sensitive component will produce a current that is dependent on the pressure that is applied to the pressure sensitive component.

Advantageously, the second component comprises a textile or fabric comprising a plurality of warp yarns, and a plurality of weft yarns. Advantageously, the warp yarns and the weft yarns are interwoven in a known manner in order to create a woven textile.

It is to be understood that the terms “warp” and “weft” as used herein are used simply in relation to the directions lengthwise and crosswise on a textile sheet, but are not necessarily used to imply any limitation on a method of fabricating a textile on a weaving loom. In addition, it is to be understood that the terms “warp” and “weft” as used herein are interchangable.

Alternatively, the textile may be non-woven and may be formed by sewing, embroidery or knitting etc.

At least some of the warp yarns and at least some of the weft yarns forming the second component are conductive.

The term “conductive” as used herein to describe yarns is to be understood to mean yarns which have an electrically conductive material on at least an outer surface of the yarn. Such yarns may be of various types of construction and may for example have an internal core of another material. The internal core may include a non-conductive material. Non-conductive yarns as defined herein are understood to be yarns having at least a non-conductive outer surface, and may be made entirely from non-conductive material or may have a conductive core.

Advantageously, the first component comprises a textile or fabric comprising a plurality of warp yarns, and a plurality of weft yarns. The warp yarns and the weft yarns are interwoven in a known manner in order to create a woven textile.

Alternatively, the textile may be non-woven and may be formed by sewing, embroidery or knitting etc.

At least some of the warp yarns and at least some of the weft yarns are conductive.

The one or more output devices are attachable to a textile forming the first component at any convenient point. Advantageously however, the output devices are attachable to a front face of the first component, the second face of the first component being in contact with the second component.

Different types of yarn and/or fibres may be used to form the first and second components. The yarn may be of single or multi filament type.

Any suitable fibres or yarns may be used to form the first and second components. For example copper, stainless steel or silver plated polyamide fibres may be used for the conductive yarns. Nylon, cotton or polyester fibres could be used for the non-conductive yarns.

The first component may be formed from a textile as claimed and described in our co-pending patent application entitled “A Fully Textile Electrode Lay-out Allowing Passive and Active Matrix Addressing” filed on even date.

Alternatively, the pressure sensitive component may comprise a plurality of pressure sensitive yarns positioned intermediate the conductive fibres.

Advantageously, the output signal of the first component is dependent upon the position of the applied pressure. Alternatively, or in addition, the output signal is dependent upon the magnitude of the applied pressure.

Due to the flexible, bendable and foldable characteristics of the textile according to the invention, the second component is able to retrieve the position at which pressure was applied to the light emitting fabric.

Advantageously the textile further comprises a power supply connectable to each of the first and second components.

Preferably, the textile further comprises a controller for controlling operation of the output device or devices.

The controller may take any convenient form, and may for example comprise a microprocessor.

Each of the first and second components is connectable to the power supply via the controller. The controller governs the operation of the output device or devices such that the output device(s) emits an output signal that is dependent upon a parameter of the applied pressure.

In some embodiments of the invention, the first and second components may be connectable directly to the power supply.

Advantageously, the controller determines which of the plurality of output devices is activated. Advantageously, the controller causes an output device to be activated that is positioned at or close to the point at which the applied pressure was applied to the textile.

In other words, when a textile according to the invention is touched, light is emitted at a location at, or close to the location at which the textile was touched.

A textile according to the present invention may be used in a variety of applications. For example, it could be used for games such as tic-tac-toe, or could be used to allow a user to make illustrations on a textile. Further, the touch sensitivity of the textile according to the present invention may be used for a variety of different interactions such as yes/no buttons.

Depending on the resolution of the weft yarns of the woven textile forming the first component, the location at which the pressure is applied will encompass at least one conductive warp yarn and one conductive weft yarn, which yarns intersect with one another.

Advantageously, the controller further comprises a first demultiplexer connected to at least some of the conductive warp yarns in the second component, and a second demultiplexer connected to at least some of the conductive weft yarns in the second component.

The controller is adapted to control the first and second demultiplexers to ensure that at least one conductive weft yarn and one conductive warp yarn from the second component are connected to the power supply.

The current that starts to flow in the at least one warp and weft yarn in the second component, in response to a pressure applied to the fabric may be measured using, for example, a resistor in series with the power supply.

Advantageously, the textile further comprises an output device driver.

When the first component comprises a plurality of light emitting diodes, the controller drives the first component such that one or more light emitting diodes are illuminated, the number and position of the illuminated light emitting diodes and the intensity of the illumination of the light emitting diodes being dependent on the position and/or magnitude of the applied pressure.

Advantageously, the output device driver is driven by the controller and is adapted to individually address output devices forming part of the first component, in response to the current measured in the second component resulting from the pressure applied to the fabric.

In a preferred embodiment, the output device driver comprises a matrix LED driver for driving a plurality of LEDs. The input signal received by the LED driver from the controller results in one or more LEDs being activated in response to the position and/or magnitude of a pressure applied to the first component.

Advantageously, the one or more output devices are attached to the first component at locations that correspond to the intersection between a conductive warp yarn and a conductive weft yarn.

This means that when a conductive warp yarn and a conductive weft yarn are connected to the power supply via the controller, an output device may be activated which has a position corresponding to the point of application of the pressure.

According to a third aspect of the present invention, there is provided a method of fabricating a touch sensitive light emitting fabric comprising the steps of:
forming a first component comprising a fabric formed from intersecting warp and weft yarns, at least some of which yarns are conductive;
attaching at least one output device to an outer face of the first component such that the output device is operably connected to a warp and weft of the first component;
forming a second component formed from intersecting warp and weft yarns, at least some of which yarns are conductive;
incorporating a pressure sensitive component into the second component;
attaching the first component to the second component such that the outer face of the first component is accessible to a user.

Advantageously, the method comprises the further steps of:
measuring current flowing in any of the second warp and weft yarns in response to a pressure applied to the fabric in order to generate output data;
using the output data to drive the output devices via the first set of warp and weft yarns.

The invention will now be further described by way of example only with reference to the accompanying drawings in which:

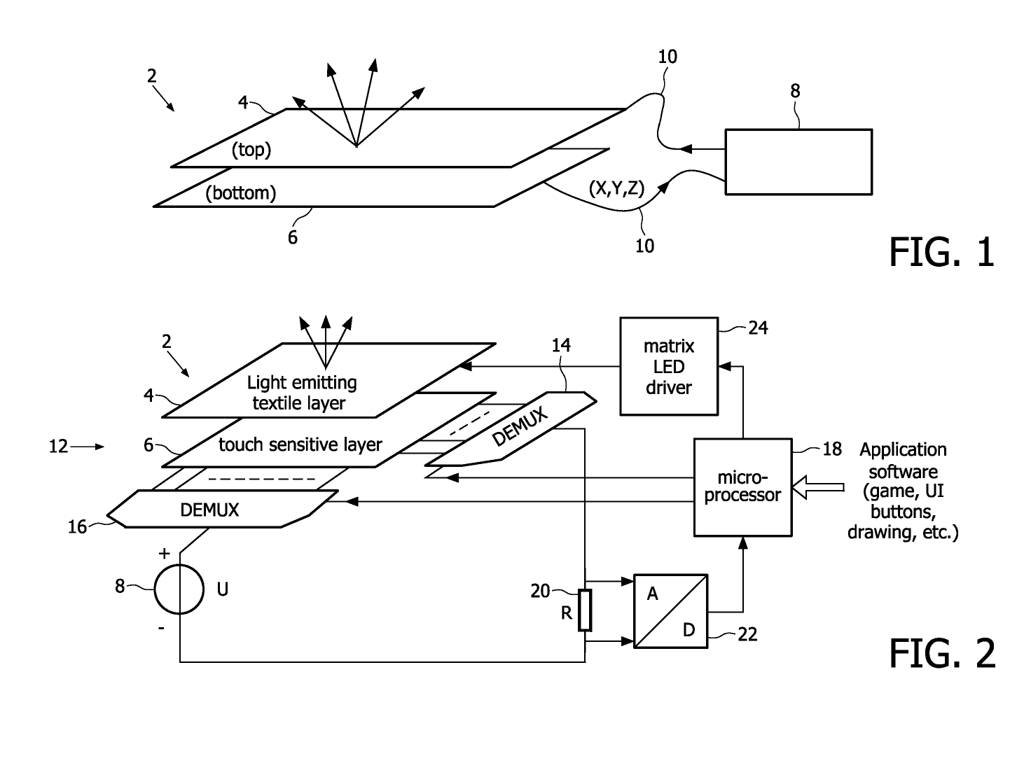

FIG. 1 is a schematic representation of an embodiment of a textile according to a first aspect of the present invention suitable for forming a touch sensitive light emitting textile device according to a third aspect of the invention;

FIG. 2 is a schematic block diagram of another embodiment of a textile according to an aspect of the present invention;

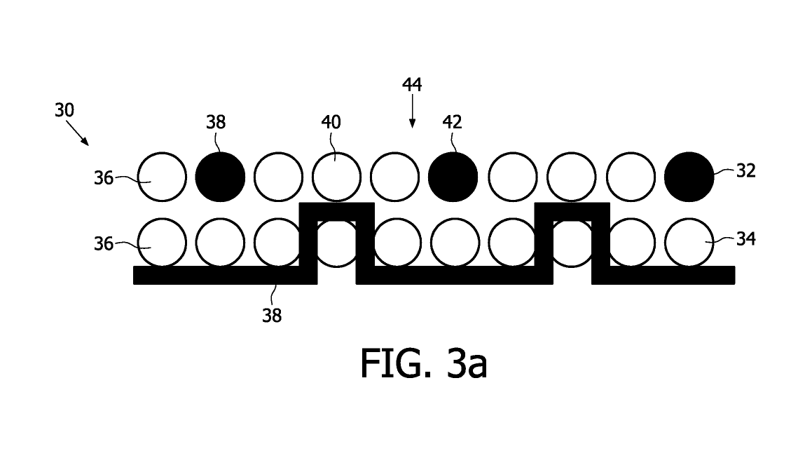

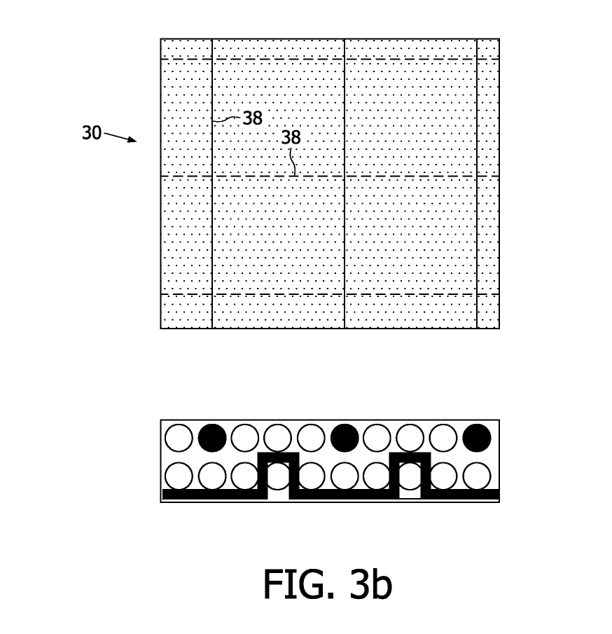

FIG. 3a is cross-sectional representation of an embodiment of the second component, a two layer woven structure forming part of a textile according to a first aspect of the present invention;

FIG. 3b is a schematic representation of the second component of FIG. 3a showing a front face thereof;

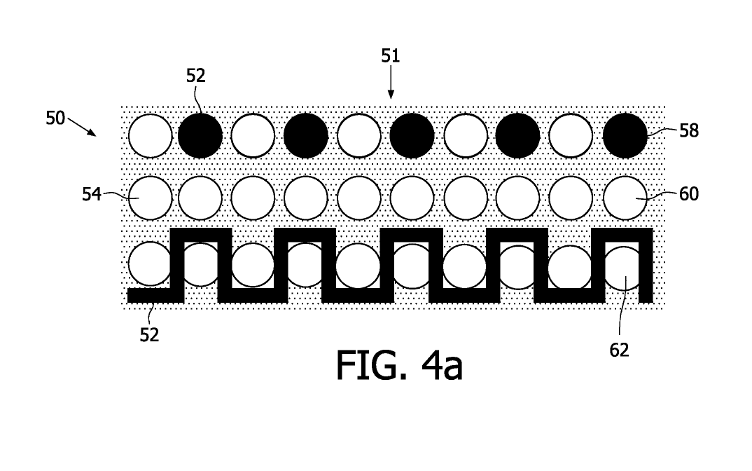

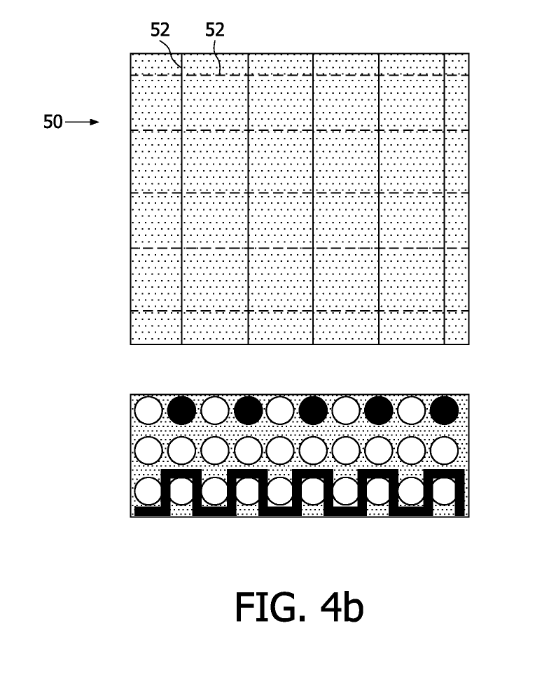

FIG. 4a is a cross-sectional representation of a three layer woven structure forming a second embodiment of a second component, part of a textile according to a first aspect of the present invention;

FIG. 4b is a schematic representation of the second component of FIG. 4a showing a front face thereof;

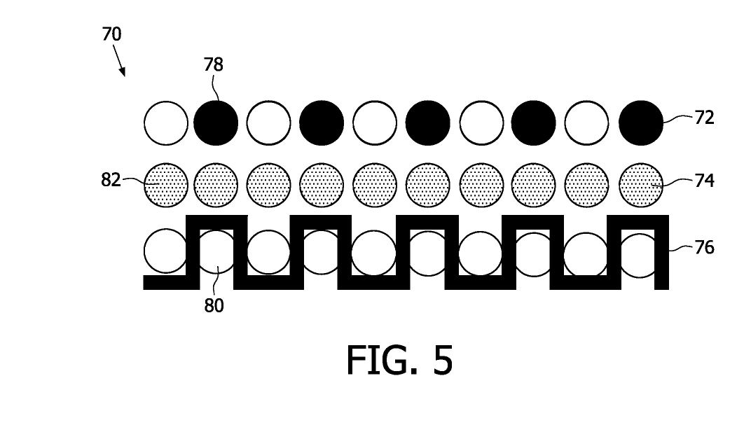

FIG. 5 is a cross-sectional representation of a third embodiment of a second component forming part of a textile according to a first aspect of the present invention;

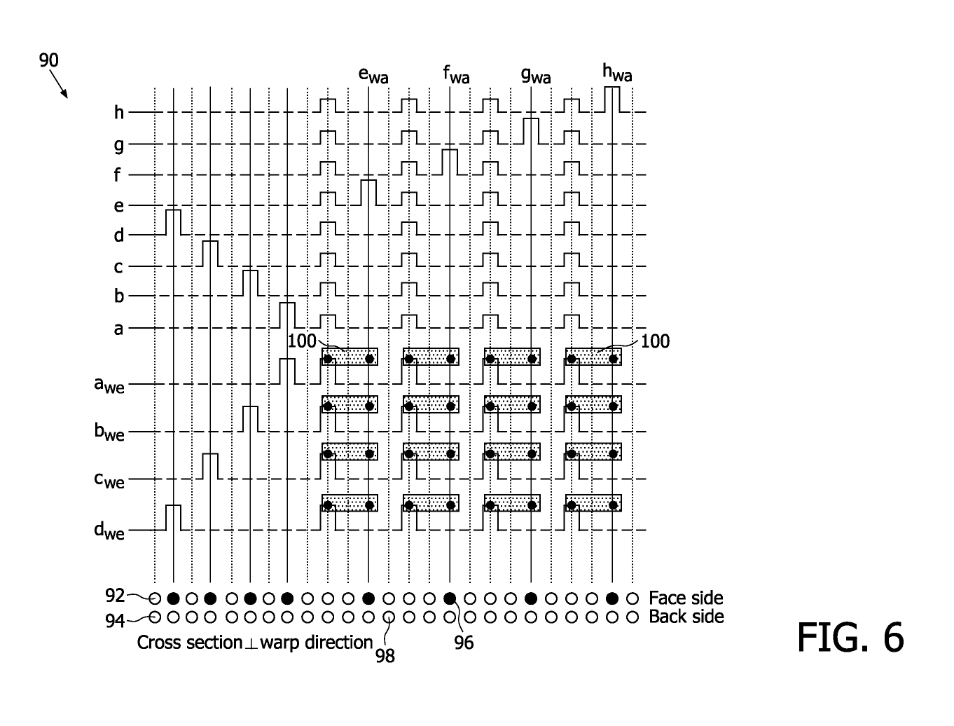

FIG. 6 is a schematic representation of an embodiment of a textile according to a second aspect of the invention comprising a two layer woven fabric containing a single sided, 4×4 single colour LED array; and

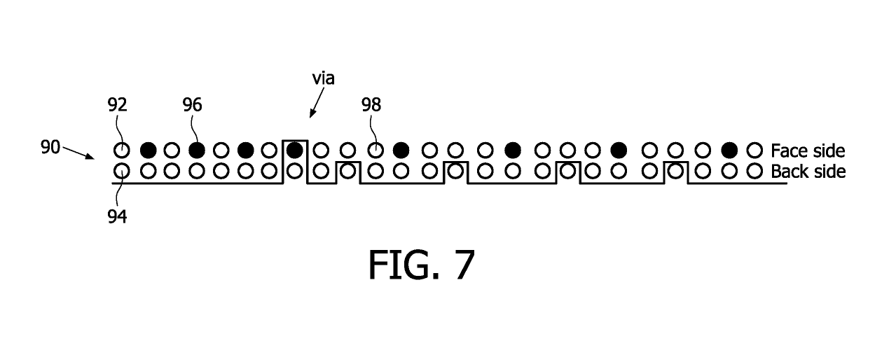

FIG. 7 is a cross-sectional representation of the woven fabric illustrated in FIG. 6 taken along weft a.

Referring to FIG. 1 a schematic representation of a textile or fabric according to an aspect of the present invention is designated generally by the reference numeral 2. The fabric 2 is suitable for forming a touch sensitive light emitting textile device as will be described in more detailed hereinbelow.

The fabric comprises a first component 4 comprising a light emitting fabric, and a second component 6 comprising a pressure sensitive component. Both the light emitting fabric 4 and the pressure sensitive component 6 are connected to a power source 8 by means of a connector 10.

Turning now to FIG. 2, the fabric 2 is shown in more detail and is shown forming part of a touch sensitive light emitting textile device designated generally by the reference numeral 12. Parts of the fabric 2 which correspond to parts illustrated in FIG. 1 have been give corresponding reference numerals for ease of reference. The pressure sensitive component 6 comprises a plurality of weft and warp yarns as will be described in more detailed hereinbelow. At least some of the weft yarns are connectable to a first demultiplexer 14, and at least some of the warp yarns are connectable to a second demultiplexer 16. The demultiplexers 14, 16 are controlled by a microprocessor 18, although other controllers could also be used. The microprocessor 18 controls the demultiplexers in accordance with the requirements of the touch sensitive light emitting textile device 12 and enables a weft yarn and a warp yarn will be connected to the power supply 8.

When pressure is applied to the fabric 2 by a person applying pressure to the touch sensitive layer 6 through the light emitting textile layer 4, a current will be produced that may be measured using a resistor 20. The current is dependent on the magnitude and location of the pressure that is applied to the touch sensitive layer 6 via the light emitting textile layer 4.

The light emitting textile layer 4 may also comprise a woven fabric comprising a plurality of warp and weft yarns. At least some of the warp and weft yarns are conductive. The first component 4 further comprises a plurality of output devices such as optical output devices. For example, first component 4 may comprise a plurality of light emitting diodes (LEDs). Each LED is connected to a conducting warp yarn and a conducting weft yarn. The warp and the weft yarns of the first component 4 intersect with one another in a known manner. Each LED will therefore be connected to a unique pair of warp and weft yarns.

When the fabric 2 is touched by a user, the touch sensitive component 6 will produce a current between a pair of warp and weft yarns which intersect at the point where the pressure is applied to the fabric 2.

By subsequently scanning each weft and warp yarn, a complete two dimension map of the applied pressure can be determined. Voltage across the resistor 20 is digitised using an analogue to digital converter 22.

The signals pertain from scanning each warp and weft yarn are fed into the microprocessor 18. The microprocessor 18 subsequently governs operation of the matrix LED driver 24. The driver 24 is programmed to address one or more predetermined LEDs in response to the pressure applied to the fabric 2.

The digital signal is fed into the microprocessor 18 which runs software that allows the device 12 to have many different applications. For example the device may be configured so that a number of different games can be played on the device, or it may be configured so that a person may draw on the device. In the latter case the user draws a pattern with a dummy pencil on the device 12. When the pencil touches the fabric the second component will register this and the output in the touched region will be switched on by 24.

The resultant device 12 provides as a soft and fully flexible interface, display, or illumination source.

The light emitting fabric layer 4 may also comprise a woven textile containing conductive rows and columns allowing passive or active matrix addressing of light emitting areas, as will be described in more detailed herein below.

Turning now to FIGS. 3, 4 and 5, embodiments of a second component of a textile according to a first aspect of the present invention forming part of the device 12 are shown in more detail.

Referring first to FIGS. 3a and 3b, a second component, or pressure sensitive layer which will form part of device 12 is designated generally by the reference numeral 30. The pressure sensitive layer 30 comprises a first set of warp and weft yarns 38 that are conductive, and a second set of warp and weft yarns 30 that are non-conductive. The yarns 38, 40 are impregnated with a second component 42 in the form of a pressure resistive ink. When the pressure sensitive component 42 is pressed in the direction of arrow 44, the ink becomes locally conductive at the point where the pressure has been applied to the fabric. This causes a current to flow from one or more of the conductive weft yarns to one or more of the conductive warp yarns.

Referring to FIGS. 4a and 4b, a second embodiment of a pressure sensitive layer forming part of a textile according to a first aspect of the present invention is designated generally by the reference numeral 50. The layer 50 comprises conductive warp and weft yarns 52, non-conducting warp and weft yarns 54, and a resistive ink impregnating the yarns 52, 54. The layer 50 comprises three layers 58, 60, 62. Layer 60 comprises non-conductive yarns only and no conductive yarns whereas layers 58, 62 comprise both conductive and non-conductive yarns. Layer 60 is positioned between layers 58 and 62 and thus provides insulation between the two layers 58, 62 which prevents short circuiting of the layer 50. When the fabric is pressed in the direction of the arrow 51, the resistive ink becomes locally conductive at the point where the pressure has been applied to the fabric. This causes the current to flow from one or more conductive weft yarns to one or more of the conductive warp yarns.

Turning now to FIG. 5, a third embodiment of a pressure sensitive layer forming a fabric according to a first aspect of the present invention is designated generally by the reference numeral 70. The layer 70 comprises three layers of yarn 72, 74, 76. Each of layers 72, 76 comprise both conducting 78 and insulating 80 yarns.

Layer 74 positioned between layers 72 and 76 comprises yarns 82, formed from a pressure resistive material. The yarns 82 may comprise entirely pressure resistive material, or may comprise fibres impregnated or sufficiently coated by such a pressure resistive material.

Turning now to FIGS. 6 and 7, a schematic representation of a fabric according to a second aspect of the invention comprises a double layer woven fabric designated generally by the reference numeral 90. The fabric 90 comprises two layers, a front (face) layer 92 and a back layer 94. Solid lines shown in FIG. 6 represent yarns in the front (face) layer 92 of the fabric 90, and dotted lines represent yarns in the back layer 94 of the fabric 90. The fabric 90 comprises conducting yarns 96 and non-conductive yarns 98. The fabric further comprises a plurality of light emitting diodes 100 forming, in this example, a 4×4 single colour light emitting diode array. The LEDs are connected to one another by conductive yarns 96 that are separated by non-conductive yarns 98.

When pressure is applied to the front side 92 of the fabric, the pressure resistive material forming the second component forming the back layer 94 (not shown in FIG. 6) will cause the current to flow at the point that the pressure is applied between intersecting conducting yarns. This current is fed into a control system of the type shown in FIG. 2. In particular, the signal will be fed into a first demultiplexer 14 and a second demultiplexer 16 (shown in FIG. 2). The signals will be processed by a microprocessor which microprocessor 18 is then used to drive a matrix LED driver individually addressing the plurality of light emitting diodes 100.

The result is that LEDs may be activated at a point corresponding to the point of application of the pressure.

The fabric illustrated in each of FIGS. 3 to 7 may be used to form the light emitting textile fabric 2 illustrated in FIG. 2. Such a fabric 2 may be used to form a touch sensitive light emitting device according to a second aspect of the present invention and as illustrated in FIG. 2.

As explained hereinabove, a fabric or textile according to the second aspect of the present invention is formed as an integral multilayer fabric. Preferably the fabric is woven.

The fabric 130 therefore comprises within it a first component which is a light emitting component, and a second component which is a pressure sensitive component. This integral fabric may therefore be substituted for the two layer fabric 2 shown in FIG. 2.

1. A textile or fabric (2) comprising:
a first light emitting component (4),
a second, pressure sensitive component (6),
the first component comprising:
an output device adapted to emit an output signal that is dependent on a parameter of an applied pressure applied to the second component via the first component.

2. A textile or fabric (2) according to claim 1 wherein the output signal is dependent on the position of the applied pressure.

3. A textile or fabric (2) according to claim 1 wherein the output signal is dependent on the magnitude of the applied pressure.

4. A textile or fabric (2) according to claim 1, further comprising a power supply.

5. A textile or fabric (2) according to claim 1, wherein the first component comprises a plurality of output devices.

6. A textile or fabric (2) according to claim 5 wherein each of the output devices each comprises a light emitting diode (100).

7. A textile or fabric (2) according to claim 1 wherein the pressure sensitive component (6) comprises a piezoresistive material.

8. A textile or fabric (30) according to claim 1, wherein the second component (42) comprises a pressure sensitive material impregnated into the first component.

9. A textile or fabric (50) according to claim 1, wherein the second component comprises plurality of pressure sensitive yarns (82).

10. A textile or fabric (30) according to claim 1, wherein the second component comprises a textile or fabric comprising a plurality of warp yarns (38, 40), and a plurality of weft yarns (38, 40).

11. A textile or fabric (30) according to claim 9 wherein the second component comprises first set (38) of warp and weft yarns each of which yarns is conductive.

12. A textile or fabric (30) according to claim 10, wherein the second component comprises a second set of warp and weft yarns (40) each of which yarns is non-conductive.

13. A textile or fabric according to claim 1, wherein the first component comprises a first set of warp and weft yarns each of which yarns is conductive.

14. A textile or fabric (2) according to claim 4 further comprising a controller (18) for controlling operation of the output device.

15. A textile or fabric (2) according to claim 14 when dependent upon claim 4, wherein the controller further comprises a first demultiplexer (14) connected to at least some of the first set of warp yarns, and a second demultiplexer (16) connected to at least some of the first set of weft yarns.

16. A method of fabricating a touch sensitive light emitting fabric (2) comprising the steps of:
forming a first component (4) comprising a fabric formed from intersecting warp and weft yarns, at least some of which yarns are conductive;
attaching at least one output device (100) to an outer face of the first component such that the output device is operably connected to a warp and weft of the first component;
forming a second component (16) formed from intersecting warp and weft yarns, at least some of which yarns are conductive;
incorporating a pressure sensitive component into the second component;
attaching the first component to the second component such that the outer face of the first component is accessible to a user.

17. A method according to claim 16 comprising the further steps of:
measuring current flowing in any of the second warp and weft yarns in response to a pressure applied to the fabric to generate output data;
using the output data to drive the output devices via the first set of warp and weft yarns.

18. A textile or fabric substantially as hereinbefore described with reference to the accompanying drawings.

19. A method substantially as hereinbefore described with reference to the accompanying drawings.
